(19) United States
(12) Patent Application Publication
(10) Pub. No.: US 2009/0153491 A1
(43) Pub. Date: Jun. 18, 2009

(54) KEY IN A KEYPAD OF AN ELECTRONIC DEVICE PROVIDING FEEDBACK

(75) Inventor: Vahid MOOSAVI, Kitchener (CA)

Correspondence Address: McCarthy Tetrault LLP, Box 48, Suite #4700 Toronto Dominion Bank Tower, TORONTO, ON, M5K 1E6, CA

(73) Assignee: Research in Motion Limited

(21) Appl. No.: 11/956,647

(22) Filed: Dec. 14, 2007

(51) Int. Cl. G06F 3/02

(52) U.S. Cl. 345/172

(57) ABSTRACT

The embodiments relate to a key in a keypad of an electronic device and a system to control the value associated with the key. The key comprises: a programmable display to generate a character associated with the key; and a switch assembly associated with the key to register activation of the key. In the key, part of the display deflects inwardly into the device when external pressure is applied to the key, and the display transmits the external pressure to the switch assembly. The key have an elastomer located between the display and the switch assembly. The display may be a cholesteric liquid crystal display.

### FIELD OF THE DISCLOSURE

The disclosure described herein relates to a key system providing an input device in an electronic device, such as a handheld electronic device. In particular, the disclosure relates to a key in a key pad which may be programmable and provides tactile feedback for the key.

### BACKGROUND OF THE DISCLOSURE

A conventional handheld electronic device, such as a Personal Digital Assistant (PDA) and a wireless telephone, includes a keyboard/keypad, a display and a system printed circuit board (PCB) disposed within a common housing. The display is typically provided as a reflective, transmissive or transreflective LCD display panel.

Existing fixed-key keypads (such as those in a computer, cellular phone or typewriter), aural and tactile feedback is provided to the user as he presses onto a key in the keypad, usually as an audible “click” and a positive (inward, downward) movement of the depressed key. Programmable keypads allow assignments for a key to change according to programmed parameters. As such, liquid crystal displays (LCDs) have been used as a substrate for virtual keypads. Typically a touch-sensitive device is incorporated into part of the LCD to provide a “switch” to register activation of the key. However, a touch screen does not provide substantial tactile feedback to the user upon activation of a key. For example, an existing haptic displays typically have a hard clear substrate covering the display area, thereby inhibiting deflection of a key in that area.

There is a need for keys and key systems which addresses at least some issues in the prior art.

### BRIEF DESCRIPTION OF THE DRAWINGS

The embodiments will now be described, by way of example only, with reference to the accompanying drawings, in which:

FIG. 1 is a top plan view of an electronic device having a key in a keypad according to an embodiment described herein;

FIG. 2 is a schematic view depicting functional details of the handheld electronic device of FIG. 1, including a display keypad and a microprocessor;

FIG. 3 is a top profile view of an embodiment of a display incorporating a keypad in the device of FIG. 1;

FIG. 4A is a top cross-sectional exploded view of the display incorporating the keypad of FIG. 3;

FIG. 4B is a side cross-sectional view of one key in the keypad of FIG. 4A in a first unactivated position;

FIG. 4C is a side cross-sectional view of the key in the keypad of FIG. 4B in a second activated and depressed position;

FIG. 5 is a side cross-sectional view of an alternative embodiment for the key in the keypad of FIG. 1 in an unactivated position; and

FIG. 6 is a side cross-sectional view of another alternative embodiment for the key in the keypad of FIG. 1 in an activated and depressed position.

### DETAILED DESCRIPTION OF EMBODIMENTS

The description which follows, and the embodiments described therein, are provided by way of illustration of an example, or examples, of particular embodiments of the principles of the present disclosure. These examples are provided for the purposes of explanation, and not limitation, of those principles and of the embodiments. In the description, which follows, like parts are marked throughout the specification and the drawings with the same respective reference numerals.

In a first aspect, a key in a keypad of an electronic device is provided. The key comprises: a programmable display to generate a character associated with the key; and a switch assembly associated with the key to register activation of the key. In the key, part of the display deflects inwardly into the device when external pressure is applied to the key, and the display transmits the external pressure to the switch assembly.

The key may further comprise an elastomer located between the display and the switch assembly. The elastomer may have a plunger extending into the device to transmit the external pressure to the switch assembly.

The key may further comprise a feedback system associated with switch assembly providing a tactile sense when the activation mechanism has registered that key has been activated.

In the key, the feedback system may comprise a collapsible dome.

In the key, the display may comprise a cholesteric liquid crystal display.

The key may further comprise a key cap located on top of the display over the switch assembly.

The key may further comprise a stem attached to key cap located on top of the display over the switch assembly, where the stem has a footprint that is smaller than the key cap.

In the key, the display may have a first rigid region about the switch assembly to transmit the external pressure to the switch assembly. In the key, the display may further have a second flexible rigid region outside of the first region to isolate the external pressure from an adjacent region in the keypad.

In the key, the display may comprise a separation region to isolate deflection of the key from the adjacent region.

In a second aspect, a system providing a programmable key in a keypad of an electronic device is provided. The system comprises: a microprocessor; a keypad module providing instructions to the microprocessor to set values for the programmable key; a display to generate a character associated with the programmable key responsive to instructions from the keypad module; a switch assembly associated with the key to register activation of the key; and data providing a plurality of values for the programmable key. In the system, the keypad module selectively assigns a value of the plurality of values for the key and instructs the display to generate an image of the value; part of the display deflects inwardly into the device when external pressure is applied to the key. The display transmits the external pressure to the switch assembly. Upon activation of the switch assembly from deflection of the display, the system initiates additional instructions responsive to the activation.

The system may further comprise an elastomer located between the display and the switch assembly. The elastomer may have a plunger extending into the device to transmit the external pressure applied to the key to the switch assembly.

The system may further comprise a feedback system associated with switch assembly providing a tactile sense when the activation mechanism has registered that key has been activated.

In the system, the feedback system may comprise a collapsible dome.

In the system, the display may comprise a cholesteric liquid crystal display.

The system may further comprise a key cap located on top of the display over the switch assembly.

The system may further comprise a stem attached to key cap located on top of the display over the switch assembly, where the stem has a footprint that is smaller than the key cap.

In the system, the display may have a first rigid region about the switch assembly to transmit the external pressure to the switch assembly.

In the system, the display may have a second flexible rigid region outside of the first region to isolate the external pressure from an adjacent region in the keypad.

In the system, the display may further comprise a separation region to isolate deflection of the key from the adjacent region.

In other aspects various combinations of sets and subsets of the above aspects are provided.

Generally an embodiment provides a keypad (key, keyboard, switch key or the like) that has an identification labels or designation that can be dynamically changed and provides tactile feedback to the user upon sufficient activation of the key. In one embodiment, the keypad is implemented in part with a liquid crystal display (LCD) that can be programmed to generate an image of a keypad, thereby allowing identification images to be generated in areas where keys for the keypad have been designated. Tactile feedback is also provided during and upon activation of a key. The feedback can be provided by a combination of one or more of a deflection of a key area in the display as the user presses on the image of the key and compression of a collapsible dome underneath the key. The dome may be part of a switch key for the keypad. The switch key may be provided by an electrical contact that is closed by the compression of the dome or the closing of a switch caused by movement of a plunger (or similar mechanical component) that is moved from a first position to a second position as the key is deflected. In other embodiments, other feedback mechanisms and other key activation systems may be provided with the programmable key. Various features of exemplary embodiments are discussed herein.

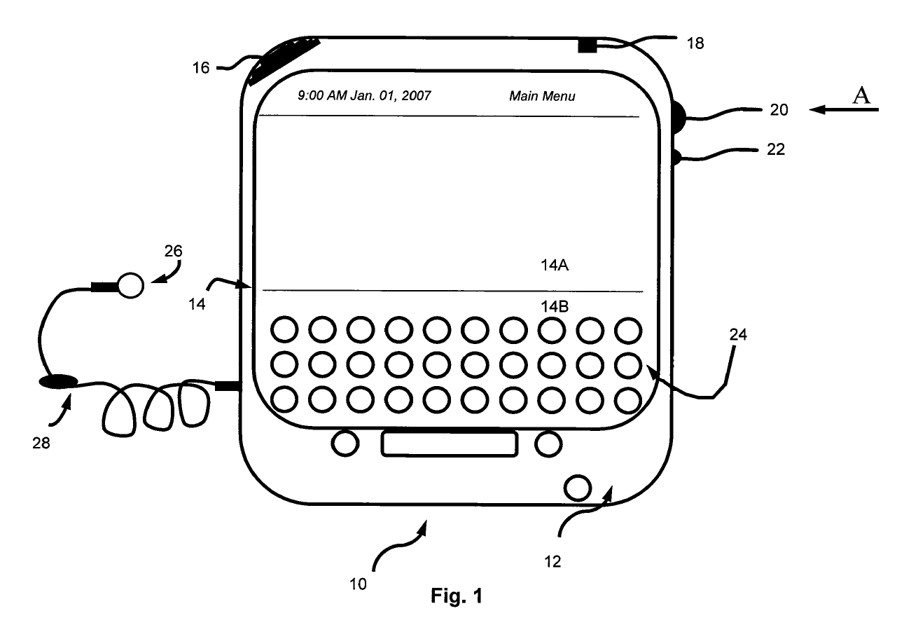

FIG. 1 provides a snapshot of typical elements associated with an embodiment. Therein, general features of a portable, electronic device are shown generally at 10. Device 10 is based on a computing platform having functionality of an enhanced personal digital assistant with a cell phone and can receive and transmit wireless communications, including as email, SMS and voice communications. Electronic device 10 can be based on construction design and functionality of other electronic devices, such as smart telephones, desktop computers, pagers or laptops having telephony equipment. In an embodiment, electronic device 10 includes a housing 12, an LCD 14, speaker 16, an light emitting diode (LED) 18, a trackball 20, an ESC (“escape”) key 22, keypad 24 (which is incorporated as part of LCD 14 in display area 14B), a wired telephone headset 30 comprised of an ear bud 26 and a microphone 28. Part of keypad 24 may be implemented as traditional fixed keys (such as the spacebar and options keys beside the spacebar as shown). Trackball 20 and ESC key 22 can be inwardly depressed along the path of arrow “A” as a means to provide additional input to device 10. It will be understood that housing 12 can be made from any suitable material as will occur to those of skill in the art and may be suitably formed to house and hold all components of device 10. Further detail on components of device 10 are provided below.

Device 10 is operable to conduct wireless telephone calls, using any known wireless phone system such as a Global System for Mobile Communications (GSM) system, Code Division Multiple Access (CDMA) system, CDMA 2000 system, Cellular Digital Packet Data (CDPD) system and Time Division Multiple Access (TDMA) system. Other wireless phone systems can include Bluetooth and the many forms of 802.11 wireless broadband, like 802.11a, 802.11b, 802.11g, etc. that support voice. Other embodiments include Voice over IP (VoIP) type streaming data communications that can simulate circuit-switched phone calls. Ear bud 26 can be used to listen to phone calls and other sound messages and microphone 28 can be used to speak into and input sound messages to device 10. Device 10 may communicate with additional remote devices or accessories, such as wireless headset (not shown).

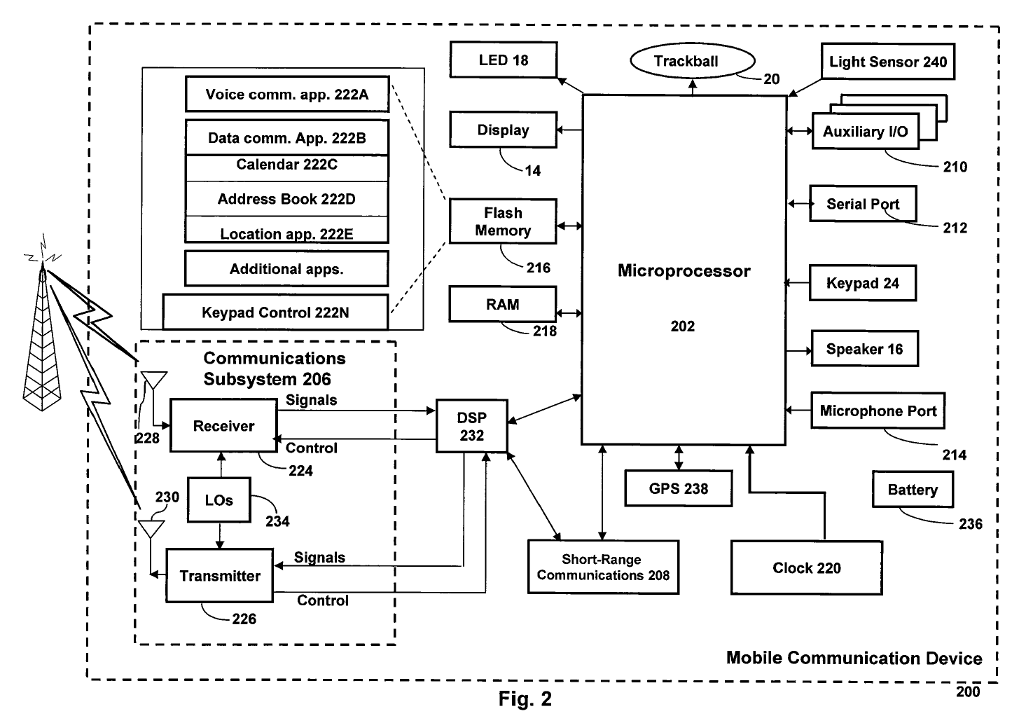

Referring to FIG. 2, functional components of device 10 are provided in schematic 200. The functional components are generally electronic, structural or electromechanical devices. In particular, microprocessor 202 is provided to control and receive almost all data, transmissions, inputs and outputs related to device 10. Microprocessor 202 is shown schematically as coupled to keypad 24 and other internal devices. Microprocessor 202 preferably controls the overall operation of the device 10 and its components. Exemplary microprocessors for microprocessor 202 include Data 950 (trade-mark) series microprocessors, the 6200 series microprocessors and the PXA900 series baseband processors, all available at one time from Intel Corporation. Microprocessor 202 is connected to other elements in device 10 through a series of electrical connections to its various input and output pins. Microprocessor 202 has an IRQ input line which allows it to receive signals from various devices. Appropriate interrupt firmware is provided which receives and reacts to the signals detected on the IRQ line.

In addition to the microprocessor 202, other internal devices of the device 10 are shown schematically in FIG. 2. These include: display 14; speaker 16; keypad 24; backlight system 242 for keypad 24; communication sub-system 206; short-range communication sub-system 208; auxiliary I/O devices 210; (serial) port 212; microphone port 214 for microphone 28; flash memory 216 (which provides persistent storage of data); random access memory (RAM) 218; clock 220 and other device sub-systems (not shown). Device 10 is preferably a two-way radio frequency (RF) communication device having voice and data communication capabilities. In addition, device 10 preferably as the capability to communicate with other computer systems via the Internet.

Operating system software executed by the microprocessor 202 is preferably stored in a computer-readable medium, such as flash memory 216, but may be stored in other types of memory devices, such as read-only memory (ROM) or similar storage element. In addition, system software, specific device applications, or parts thereof, may be temporarily loaded into a volatile store, such as RAM 218. Communication signals received by the mobile device may also be stored to RAM 218.

Microprocessor 202, in addition to its operating system functions, enables execution of software applications on device 10. A set of software (or firmware) applications, generally identified as applications 222, that control basic device operations, such as voice communication application 222A and data communication application 222B, may be installed on the device 10 during manufacture or downloaded thereafter. As well, software applications, such as calendar application 222C, address book 222D and location application 222E. Keypad application 222N can generate a plurality of keyboard “maps” as two-dimensional images of keypad layouts. Additional applications such as personal information manager (PIM) application may be provided. Any application may be installed during manufacture or downloaded thereafter into device 10. Data associated with each application can be stored in flash memory 216.

Communication functions, including data and voice communications, are performed through the communication sub-system 206 and the short-range communication sub-system 208. Collectively, sub-systems 206 and 208 provide the signal-level interface for all communication technologies processed by device 10. Various applications 222 provide the operational controls to further process and log the communications. Communication sub-system 206 includes receiver 224, transmitter 226 and one or more antennas, illustrated as receive antenna 228 and transmit antenna 230. In addition, communication sub-system 206 also includes processing modules, such as local oscillators (LOs) 234. The specific design and implementation of communication sub-system 206 is dependent upon the communication network in which device 10 is intended to operate. For example, communication sub-system 206 of device 10 may operate with the Mobitex (trade-mark), DataTAC (trade-mark) or General Packet Radio Service (GPRS) mobile data communication networks and also operate with any of a variety of voice communication networks, such as Advanced Mobile Phone Service (AMPS), Time Division Multiple Access (TDMA), Code Division Multiple Access (CDMA), CDMA 2000, Personal Communication Service (PCS), Global System for Mobile Communication (GSM), etc. Other types of data and voice (telephonic) networks, both separate and integrated, may also be utilized with device 10. In any event, communication sub-system 206 provides device 10 with the capability of communicating with other devices using various communication technologies, including instant messaging (IM) systems, text messaging (TM) systems and short message service (SMS) systems.

Digital signed processor (DSP) 232 may be provided to assist in processing raw digital signals and commands from microprocessor 202 to sub-system 206. In addition to processing communication signals, DSP 232 provides control of receiver 224 and transmitter 226. For example, gains applied to communication signals in receiver 224 and transmitter 226 may be adaptively controlled through automatic gain-control algorithms implemented in DSP 232.

In a data communication mode, a received signal, such as a text message, Web page download or command from headset 40, is processed by the communication sub-system 206 and is provided as an input to microprocessor 202. The received signal is then further processed by microprocessor 202 which can then generate an output to display 14 or to an auxiliary I/O device 210. A device user may also compose data items, such as e-mail messages, using keypad 24, trackball 20 and/or some other auxiliary I/O device 210, such as a touchpad, a rocker switch, a trackball or some other input device. The composed data items may then be transmitted over communication network 140 via communication sub-system 206. Sub-system 206 may also detect when it is out of communication range for its remote systems.

In a voice communication mode, overall operation of device 10 is substantially similar to the data communication mode, except that received signals are output to speaker 16, and signals for transmission are generated by microphone 28. Alternative voice or audio I/O sub-systems, such as a voice message recording sub-system, may also be implemented on device 10. In addition, display 14 may also be utilized in voice communication mode, for example, to display the identity of a calling party, the duration of a voice call, or other voice call-related information.

Short-range communication sub-system 208 enables communication between device 10 and other proximate systems or devices, which need not necessarily be similar devices. For example, the short-range communication sub-system may include an infrared device and associated circuits and components, or a Bluetooth (trade-mark) communication module to provide for communication with similarly enabled systems and devices. Short range communication system 208 may be used as the signal communication interface for device 10 and other devices. DSP 232 may process some of the commands and signals destined for the other devices.

Powering the entire electronics of the mobile handheld communication device is power source 236. In one embodiment, power source 236 includes one or more batteries. In another embodiment, power source 236 is a single battery pack, especially a rechargeable battery pack. A power switch (not shown) provides an “on/off” switch for device 10. A power source interface (not shown) may be provided in hardware, firmware, software or a combination of such elements to selectively control access of components in device 10 to power source 236. Upon activation of the power switch an application 222 is initiated to turn on device 10. Upon deactivation of the power switch, an application 222 is initiated to turn off device 10. Power to device 10 may also be controlled by other devices and by software applications 222.

Device 10 may also have global positioning system 238 to assist in identifying a present location of device 10 and may also have light sensor 240 to provide data on the ambient light conditions for device 10. If the detected ambient light levels are sufficiently low, a backlight system may be activated. These elements may be controlled by software operating on device 10 as described earlier.

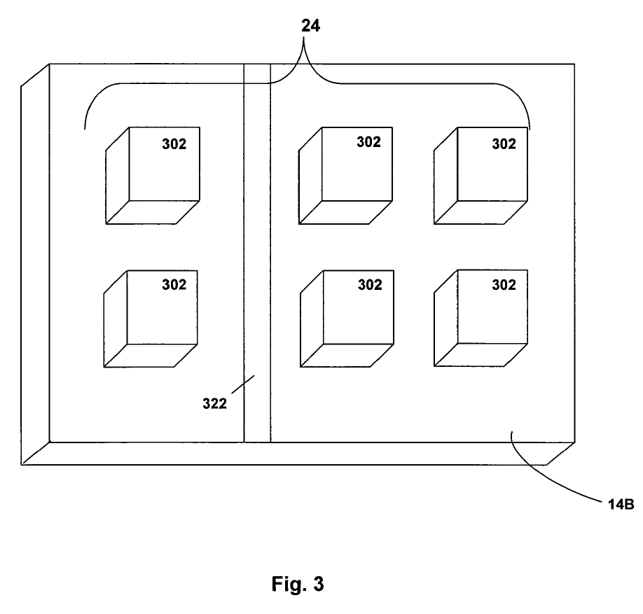

Referring to FIGS. 1, 3 and 4A, LCD 14 comprises sections 14A and 14B. It will be appreciated that the display region 14B in LCD 14 can be used as a keypad 24 which is divided into a set of virtual keys. Each key is covered by a key cap 302. As such, display 14B presents a virtual keyboard layout on device 10. As LCD 14B is a display, keypad control module 222N can be provided with a series of templates to allow one or more of keys in keypad 24 to have different assignments depending on a context of the operating environment of device 10. For example, one layout for keypad 24 is a standard QWERTY keyboard layout. One variant of a QWERTY layout is to present a layout of keys in lower case, as “qwerty” characters. An alternative QWERTY layout is to present a layout of keys in uppercase, as “QWERTY” characters. Other layouts include a layout for numeric keys, a layout for non-English language character sets (e.g. Japanese, French, Korean, Danish, and others). For the particular instance, the key is the “A” key, as shown with a border. The area with the border is covered by cap 302. In other embodiments the border may not be generated. A backlight system may be provided for display 14B to assist with viewing elements in keypad 24 in low light conditions, which may be controlled in part by keypad control module 222N.

In one embodiment display 14B within the keyboard region is a cholesteric LCD. A cholesteric LCD is bi-stable and can be programmed to have its display to be set and then the power may be disengaged from display 14B. As such, no power or very little power is required to maintain an image of the key for display 14B. Also, LCD 14B is a cholesteric reflective display. A feature of a cholesteric display is that it is a reflective bi-stable technology, as such allowing a passive matrix to produce a relatively high-resolution image. A cholesteric keypad does not necessarily require a coloured filter to display a colour image. Further, a cholesteric substrate is pliable and may be deflected, thereby allowing a key are shown on display 14B to be depressed when key cap 302 is pressed by a user.

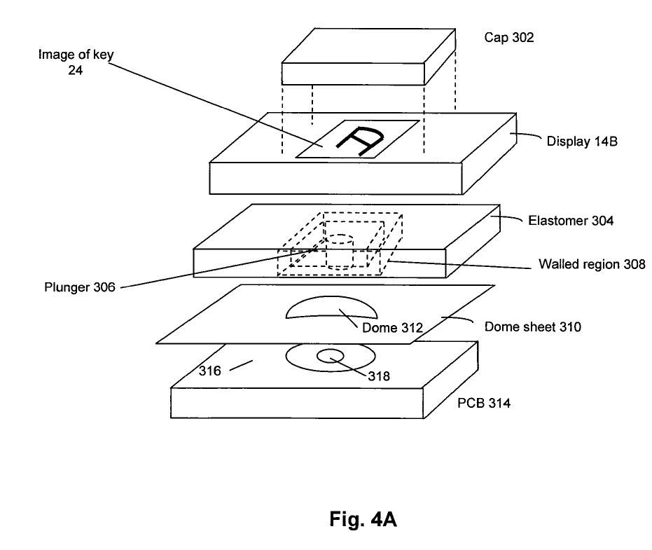

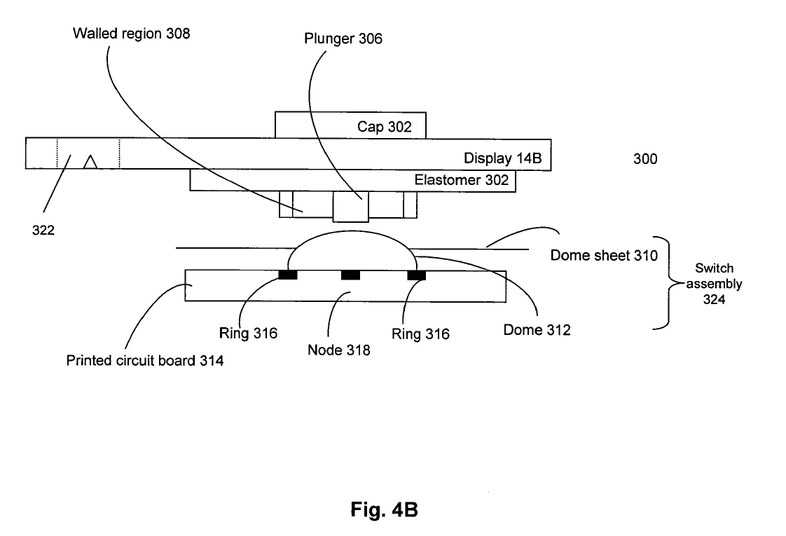

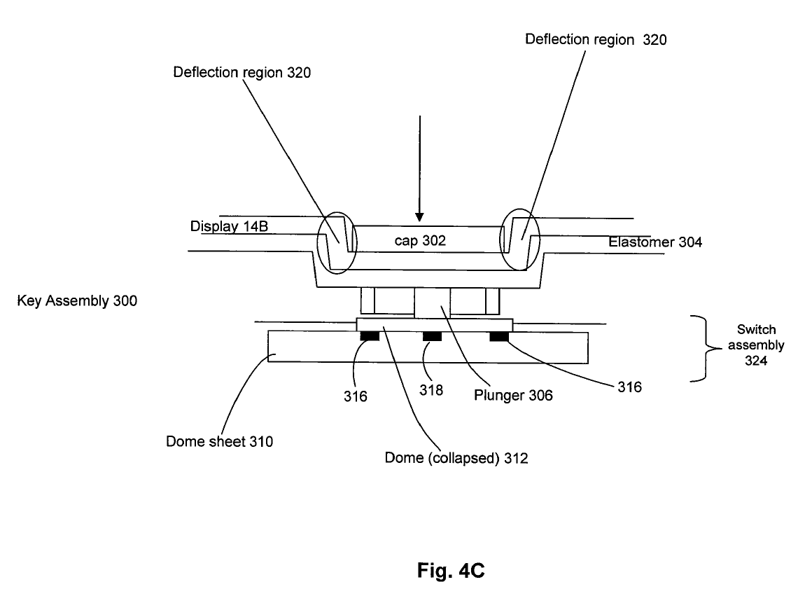

Referring to FIGS. 4A to 4C further details are shown on selected elements of key assembly 300. While these figures show one key, it will be appreciated that the embodiment may be for a single key, a group of keys or all keys in keypad 24. In an embodiment, key 24 in keypad 24 is shown. For a given key 24, key assembly 300 is provided, which includes the following elements: key cap 302, switch assembly 324 and elastomer 304 providing key plunger 306. Elastomer 304 transmits the external (downward, inward) pressure applied to the exterior key 24 to switch assembly 324. Switch assembly 324 registers “closing” of the key when it is sufficiently activated by elastomer 324. In other embodiments a key assembly may not have certain elements, such as an elastomer or a biasing mechanism. In other embodiments, a key assembly may have additional components.

In FIG. 4A, cap 302 is shown as fitting over a region in display 14B that has been designated as a key. Key cap 302 is generally a flat, thin, rigid and transparent section of polycarbonate that is shaped to fit to be the size of a regular key in keypad 24. One function of cap 302 is to transmit the inward, downward external force applied by the user when activating the key to the key activation mechanism 300. As such, cap 302 in FIG. 4A assists in stiffening the exposed exterior area around virtual key in display 14B. Cap 302 may be glued or welded individually to the key region above its local key area for display 14B. Alternatively, cap 302 may be mounted on or moulded with a substrate with other caps 302 for the keypad and the substrate may be laid on top of display 14B.

Cap 302 is shown as a separate component for a specific key. In other embodiments, a connected or continuous substrate in which cap 302 is an element may be provided that is laid over display 14B and a region of keypad 24. In such a substrate, individual keys may be connected to each other by a web or other material. Such a web may be thinner in thickness than cap 302 and/or may be made from a (more) flexible material, in order to isolate movement of cap 302 from adjacent caps 302.

Referring to FIGS. 4A and 4B, further detail is provided on the key assembly 300 underneath display 14B. Elastomer 304 provides a flexible sheet that engages with dome sheet 310 is located underneath display 14B and provides a physical interface for concentrating activation pressure of the deflection of cap 302 and display 14B. Elastomer 304 may be made from a silicon based material. For a particular key, elastomer 304 provides walled region 308 to define a physical boundary for the key within elastomer 304. In other embodiments, walled region 308 may not be needed. Switch assembly 324 comprises dome sheet 310 and an electrical circuit in PCB 314.

As shown in FIG. 4A, within walled region 308, plunger 306 descends from the bottom of elastomer 304 towards the interior of device 10. As shown, when key and cap 302 is in a first, resting position, plunger 306 is located above or on top of contact dome 312 of dome sheet 310. The material of elastomer 304 is sufficiently rigid to cause dome 312 as plunger 306 imparts a downward force on it. Underneath dome 312, printed circuit board 314 has an electrical circuit between exterior ring 316 and interior node 318.

Referring to FIG. 4C, features of a key in keypad 22 are shown as a user activates the key by exerting a (downward, inward) external pressure on it, as per a typical key activation motion. As key cap 302 is depressed by a user, display 14B and elastomer 304 are deflected towards the interior of device 10. Display 14B buckles inwardly at regions 320 as shown. The ability for display 14B to buckle at region 320 is determined at least in part by the composition of display 14B. As such, the thickness of the layers in the substrate of LCD 14B with a specific materials used therein affect the flexibility of such areas. It will be appreciated that the area of display 14B that is directly underneath cap 302 may be sufficiently rigid to transmit the downward force to other components in key assembly 300.

As key cap 302 is moved downward, plunger 306 presses on dome 312 in switch assembly 324 and dome 312 begins to collapse. When dome 312 fully collapses, it bridges an electrical connection between exterior ring 316 and interior node 318 on PCB 314. Completion of this connection can be used to signify the closing of the switch for the “A” key. As such, keypad control module 222N recognizes this signal condition and can then react accordingly. The reaction may be one or more of generating the related character on display 14A and/or providing a suitable response per the underlying application currently operating on device 10. When dome 312 collapses as shown, it generates a familiar “clicking” sound upon its compression. The collapse provides another tactile feedback system to the user of the activation of the key. Upon release of cap 302, a clicking sound is also generated with the springing back of dome 312 to its original shape, as shown in FIG. 4B. It will be appreciated that a switch assembly can comprise other contact recognition or state change recognition devices, such as proximity sensors, strain gauges, heat sensors and the like which have at least two states (e.g. open circuit and closed circuit), which may be used to indicate the closing an electrical circuit upon the sufficient deflection of a key.

It will be appreciated that key cap 302 has a function of dispersing the pressure applied by the user for the particular key and evening out the applied pressure throughout that area of the key cap 302. As such, key cap 302 allows engagement of the representative key, even if key cap 302 is depressed with pressure applied to an area along its edge.

When a particular region for a key in display 14B is depressed, a feature of an embodiment attempts to isolate the depression, such that the depression does not become recognized as an activation of an adjacent virtual key. In an embodiment, sufficient isolation among adjacent keys may be provided by a combination of one or more of the following factors: i) providing a sufficient distance between keys; ii) selecting the composition and physical design of the key area of display 14B such that when one key area is depressed, the deflection of the target area in display 14B is localized to that area. For example for factor ii), the substrate of display 14B may be rigid enough in a first region about key assembly 300 and switch assembly 324 to transmit the deflection to key assembly 300 and flexible enough to allow the deflection and still flexible enough in a second region about the first region to isolate the deflection movement to adjacent regions (including regions with other keys). The composition of materials and structures in the first and second regions may be the same or different to achieve both characteristics. In such an instance, key cap 302 may not be required. Additionally or alternatively, to assist in same, referring to FIG. 4A, separation region 322 may be provided along and between adjacent regions (which may include selected keys in keypad 24). Separation region 322 may comprise one or more of a web, ridge, fold, notch and or bevel and may have a thinner thickness than dimension changes physical designs in the display substrate therein to assist in providing further physical separation between adjacent keys. There may or may not be part of an active display component (e.g. LCD component) in separation region 322.

It is noted that display 14B provides a single substrate which does not expose elements of key assembly 300 to the elements, thereby providing water resistant capabilities for covered key elements 300 in an embodiment.

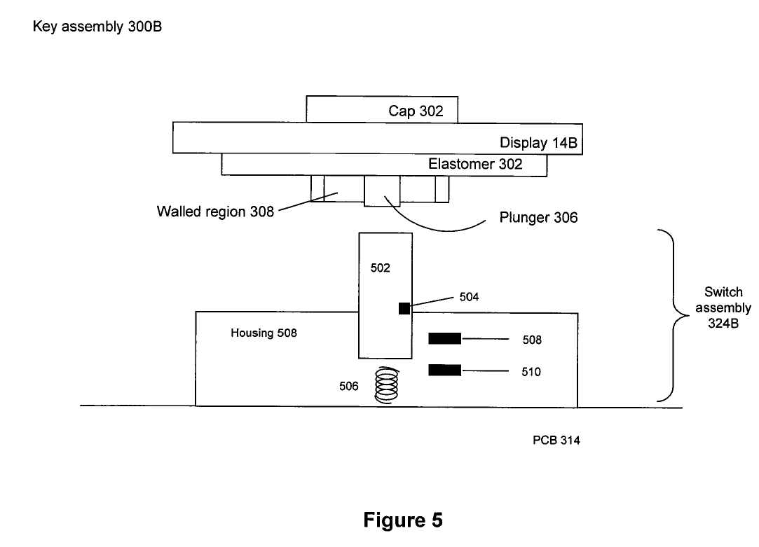

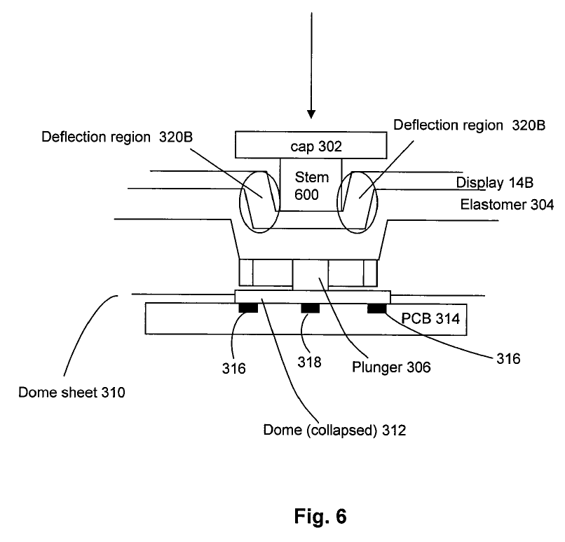

It will be appreciated that other keys and switch assemblies may be provided to generate an activation signal for a particular key using other technologies in combination with display 14B. One alternative switch assemblies is shown in FIG. 5. One alternate cap is shown in FIG. 6.

Referring to FIG. 5, key assembly 300B is shown incorporating switch assembly 324B is shown. Therein, display 14B, cap 302 and elastomer 304 are as provided in FIG. 4A. However, switch mechanism 500 provides a cylindrical barrel 502 having switch contacts thereon; it is moveable from a first vertical position to a second vertical position by plunger 306 and electrical contact area 504 on a side of its barrel. Biasing spring 506 is located between PCB 314 and the bottom of barrel 502. Biasing spring 506 provides a compressible element which biases barrel 502 upward. As switch assembly 324B is depressed, biasing spring 506 imparts an incrementally increasing upward force to resist the downward force being imparted. Upon release of the key cap 302, biasing spring 506 forces key cap 302 upward to its resting position. Although biasing spring 506 is shown as a coiled spring, in other embodiments it may be implemented as a leaf spring, a resilient puck (e.g. made from rubber or foam) or any other compressible, resilient mechanical arrangement which imparts an upward bias onto barrel 502. Housing 508 provides structural support to elements of switch assembly 324B, without unduly restricting movement of its elements described herein.

In use, as downward pressure is imparted on key cap 302 and display 14B deflects downward, barrel 502 moves downward towards the interior of device 10. As barrel 502 moves downward, contact 504 moves downward as well and passes by contact 504, noted as reference 508. This contact point completes an electrical signal between contact 504 and contact areas 504, thereby allowing an appropriate signal may to be generated by device 10. As cap 302 is further depressed, barrel 502 passes through contact 508. Then, barrel 502 move further downward and eventually passes contact 510. At contact 510, another circuit can be closed, which can initiate a second activation signal to device 10. When the user lifts his finger from key cap 302, biasing spring 506 forces barrel 502 and plunger 306 upward, thereby assisting in returning the deflected part of display 14B to its original, flat form. In other embodiments a suitable biasing mechanism may be implemented as a leaf spring, a resilient puck (e.g. made from rubber or foam) or any other compressible, resilient mechanical arrangement which imparts an upward bias onto plunger 306.

Referring to FIG. 6, it will further be appreciated that in other embodiments, cap 302 may be shaped in difficult sizes and the spacing of key and key caps may be shaped to have a smaller contact area localized to around the dome or contact pad. Shown in FIG. 6, cap 302B may be mounted on top of stem 600, which has a footprint area that is smaller than the footprint of cap 302B on display 14B. Stem 600 may be positioned to be above the center of dome 312 or above switch mechanism 500, if it is implemented. As such, the deflected region 320B of display 14B is more localized around dome 312 than deflection region 320 in FIG. 4C. The specific size and shape of stem 600 may taper to localize the force being applied towards elastomer 306.

In other embodiments, cap 302 may not be provided at all to one or more keys in keypad 24, the size thereof may not be needed, depending on the size of the key that is defined and the flexibility characteristic of display 14B on that particular region.

It will be appreciated in other embodiments, separate displays may be provided for each key and such that each display for each key (of related set of keys) is capable of being deflected independently or with reduced interaction if adjacent keys. Additionally or alternatively sets of individual displays may be connected by webs. Additionally or alternatively further still, a single display 14B may be physically segmented into separate keys, with each key being separated by a separation zone 322.

Additionally or alternatively, one or more of the keys within keypad 24 may have an activation system that is embodied through one of a heat, touch or other electrical contact technology. For example, a switch mechanism may be provided where a barrel has a plurality of contacts thereon.

It will be appreciated that modules 222 operating on microprocessor 202 in the embodiments can be implemented using known programming techniques, languages and algorithms. The titles of the modules are provided as a convenience to provide labels and assign functions to certain modules. It is not required that each module perform only its functions as described above. As such, specific functionalities for each application may be moved between applications or separated into different applications. Modules may be contained within other modules. Different signalling techniques may be used to communicate information between applications using known programming techniques. Known data storage, access and update algorithms allow data to be shared between applications. It will further be appreciated that other applications and systems on device 10 may be executing concurrently with any module 222. As such, one or more aspects of keypad activation module 222N may be structured to operate in as a “background” application on device 10, using programming techniques known in the art.

The present disclosure is defined by the claims appended hereto, with the foregoing description being merely illustrative of embodiments. Those of ordinary skill may envisage certain modifications to the foregoing embodiments which, although not explicitly discussed herein, do not depart from the scope of the embodiments, as defined by the appended claims.

1. A key in a keypad of an electronic device, comprising:
a programmable display to generate a character associated with said key;
a switch assembly associated with said key to register activation of said key,
wherein part of said display deflects inwardly into said device when external pressure is applied to said key, and said display transmits said external pressure to said switch assembly.

2. The key in a keypad of an electronic device as claimed in claim 1, further comprising:
an elastomer located between said display and said switch assembly, said elastomer having a plunger extending into said device to transmit said external pressure applied to said key to said switch assembly.

3. The key in a keypad of an electronic device as claimed in claim 2, further comprising
a feedback system associated with switch assembly providing a tactile sense when said activation mechanism has registered that key has been activated.

4. The key in a keypad of an electronic device as claimed in claim 2, wherein said feedback system comprises a collapsible dome.

5. The key in a keypad of an electronic device as claimed in claim 2, wherein said display comprises a cholesteric liquid crystal display.

6. The key in a keypad of an electronic device as claimed in claim 5, further comprising a key cap located on top of said display over said switch assembly.

7. The key in a keypad of an electronic device as claimed in claim 6, further comprising a stem attached to key cap located on top of said display over said switch assembly, said stem having a smaller footprint than said key cap.

8. The key in a keypad of an electronic device as claimed in claim 5, wherein said display has a first rigid region about said switch assembly to transmit said external pressure to said switch assembly.

9. The key in a keypad of an electronic device as claimed in claim 8, wherein said display has a second flexible rigid region outside of said first region to isolate said external downward pressure from an adjacent region in said keypad.

10. The key in a keypad of an electronic device as claimed in claim 9, wherein said display comprises a separation region to isolate deflection of said key from said adjacent region.

11. A system providing a programmable key in a keypad of an electronic device, comprising:
a microprocessor;
a keypad module providing instructions to said microprocessor to set values for said programmable key;
a display to generate a character associated with said programmable key responsive to instructions from said keypad module;
a switch assembly associated with said key to register activation of said key; and
data providing a plurality of values for said programmable key,
wherein
said keypad module selectively assigns a value of said plurality of values for said key and instructs said display to generate an image of said value;
part of said display deflects into said device when external pressure is applied to said key, transmitting said external pressure to said switch assembly; and
upon activation of said switch assembly from deflection of said display, said system initiates additional instructions responsive to said activation.

12. The system providing a programmable key as claimed in claim 11, further comprising:
an elastomer located between said display and said switch assembly, said elastomer having a plunger extending into said device to transmit said external pressure applied to said key to said switch assembly.

13. The system providing a programmable key as claimed in claim 12, further comprising
a feedback system associated with switch assembly providing a tactile sense when said activation mechanism has registered that key has been activated.

14. The system providing a programmable key as claimed in claim 12, wherein said feedback system comprises a collapsible dome.

15. The system providing a programmable key as claimed in claim 12, wherein said display comprises a cholesteric liquid crystal display.

16. The system providing a programmable key as claimed in claim 15, further comprising a key cap located on top of said display over said switch assembly.

17. The system providing a programmable key as claimed in claim 16, further comprising a stem attached to key cap located on top of said display over said switch assembly, said stem having a smaller footprint than said key cap.

18. The system providing a programmable key as claimed in claim 17, wherein said display comprises a separation region to isolate deflection of said key from an adjacent region in said keypad.

19. The system providing a programmable key as claimed in claim 15, wherein said display has a first rigid region about said switch assembly to transmit said external downward pressure to said switch assembly.

20. The system providing a programmable key as claimed in claim 19, wherein said display has a second flexible rigid region outside of said first region to isolate said external downward pressure from an adjacent region in said keypad.
